(19) United States
(12) Patent Application Publication
(10) Pub. No.: US 2018/0023318 A1
(43) Pub. Date: Jan. 25, 2018

(54) KEY SAFE FOR MOUNTING ON A SURFACE

(71) Applicant: SUDHAUS GmbH & Co. KG, Iserlohn (DE)

(72) Inventors: Antonio DI GIOVANNI, Altena (DE); Michael HARTMANN, Iserlohn (DE)

(21) Appl. No.: 15/550,822

(22) PCT Filed: Mar. 3, 2016
(86) PCT No.: PCT/EP2016/000414

§ 371 Date: Sep. 15, 2017

(30) Foreign Application Priority Data
Mar. 13, 2015 (DE) 10 2015 003 171.6

(51) Int. Cl. E05B 19/00; E05B 37/02; E05B 37/00; E05G 1/02; E05G 1/04

(52) U.S. Cl. CPC E05B 19/0005; E05G 1/02; E05G 1/04; E05B 37/0086; E05B 37/02

(57) ABSTRACT

A key safe (1) to be attached to a mounting surface has a wall element (4), which can be fixed on the mounting surface and onto which at least one key can be fastened, a housing part (13), by means of which the wall element (4) and optionally the at least one key can be covered, and a combination lock (2), by means of which the wall element (4) and the housing part (13) can be locked to one another when the key safe (1) is closed. In order to make a key safe (1) of this type more mechanically stable and actuatable in a more simple way with a comparatively low technical and constructive effort, it is proposed in the present invention that the housing part (13) is configured to be round on its edge (14) allocated to the wall element (4), that the housing part (13) can be rotated relative to the wall element (4) when the key code is set on the combination lock (2), and that the housing part (13) can be removed from the wall element (4) after a rotation about a prcdcterminablc angle of rotation relative to the wall element (4).

The invention relates to a key safe for attachment to a mounting surface and having a wall part that can be fixed to the mounting surface and on which at least one key can be held, a housing that can cover the wall plate and, optionally, the at least one key, and a combination lock that can secure the wall plate and the housing to one another when the key safe is closed.

Such a key safe from the prior art usually has a box that can be fixed to the mounting surface on which a plate is arranged that can be pivoted onto the box, a combination lock, for example, securing the plate against moving. When the key code of the combination lock is set, an unlocking mechanism is actuated, causing the cap to pivot out when the key code is set so that the interior of the box is rendered accessible by the opening movement.

Such key safes have proven to be relatively vulnerable to mechanical break-in attempts and the like.

Taking the prior art described above as a point of departure, it is the object of the invention to modify a key safe of the above-described type such that, with little technical and constructive effort, it is mechanically stronger while remaining simple to actuate and operate.

This object is achieved according to the invention in that the housing is formed so as to have a generally circular edge turned toward the wall plate, in that the housing can be rotated relative to the wall plate when the key code is set on the combination lock, and in that, after rotation through a predetermined angle relative to the wall plate, the housing is separable from the wall plate. By virtue of the rotatable design of the housing relative to the wall plate, substantially fewer points of attack that could be used to mechanically break the key safe open are created in comparison to the prior art.

If the key safe according to the invention is equipped with a wiping mechanism that deletes the key code of the combination lock and that includes an adjustment mechanism of the combination lock and a control cam that, after the key code is set on the combination lock and the housing, can shift coding elements of the combination lock relative to the wall plate out of the position they are set in, which corresponds to the key code, to ensure that it is quasi impossible for an unauthorized party to determine the key code when the key safe is opened, since the key code of the combination lock always remains set only for an extremely short period of time.

According to an advantageous embodiment of the key safe according to the invention, the angle of rotation of the housing relative to the wall plate is about 60°, with the control cam of the wiping mechanism extending over about 25° to 45°.

In order to ensure with minimum complexity that the housing remains in proximity of the wall plate, it is advantageous if the housing of the key safe is connected by a wire, a band, or the like to the wall plate.

The combination lock is advantageously arranged in the a dome or cap forming the housing, and the control cam is advantageously on the wall plate. The combination lock can be securely received inside the dome- or cap-shaped housing, and the operationally reliable supporting of the combination lock in the housing can be ensured by a suitable retaining plate.

In order to give the housing an especially robust mechanical design, the housing that is a dome or cap is hemispherical with a cylindrical portion on its edge that fits with the wall plate and a flat portion that is arranged so as to be spaced from and parallel to the wall plate.

The wall plate is advantageously circular and has an outer edge formed with a circular groove in which the edge of the housing directed toward the wall plate can fit.

The combination lock of the key safe advantageously has a latch member that, when the key safe is closed and the combination lock has been moved out of the key code, is in blocking engagement with latch formations on the wall plate, and when the key code of the combination lock is set, can be released from the blocking engagement with the wall-plate latch formations.

In order to ensure the secure fixation of the housing on the wall plate—including during rotation—it is advantageous if a bayonet joint is formed between the housing and the wall plate of the key safe that can only be opened when the key code has been set on the combination lock and the housing has been rotated by the predetermined angle of rotation relative to the wall plate.

To facilitate actuation or rotation of the cap- or dome-like housing, it is advantageous if grip recesses are formed on the outer surface of the dome or cap.

The invention will be described below in further detail with reference to an embodiment shown in a drawing in which:

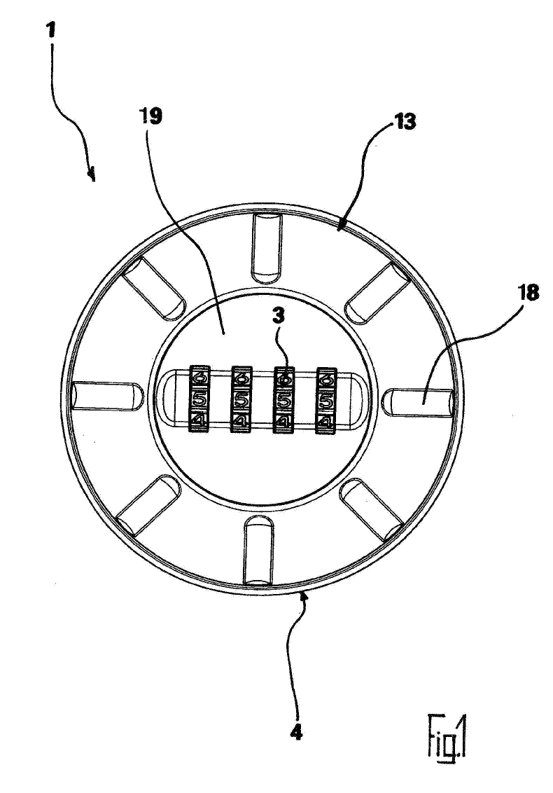

FIG. 1 is a top view of an embodiment of a surface-mount key safe according to the invention; and

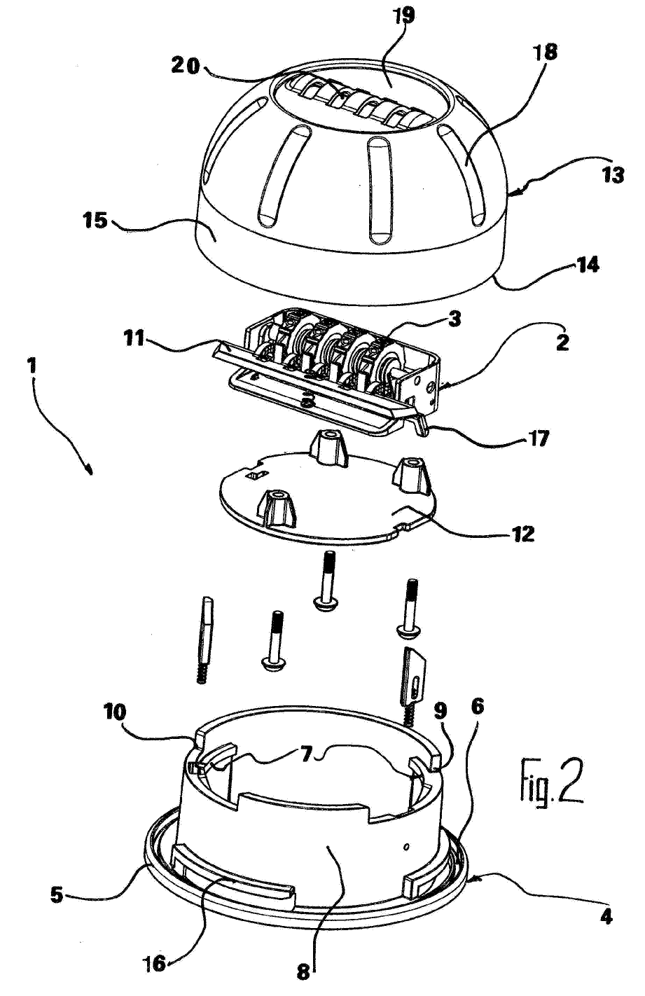

FIG. 2 is a perspective, exploded representation of the embodiment of the surface-mount key safe according to the invention shown in FIG. 1.

A key safe 1 shown in FIGS. 1 and 2 in an exemplary embodiment is attached to a mounting surface (not shown in the figures) and is used for safekeeping one or more keys, for example a spare key. At least one key (also not shown in the figures) can be deposited in the key safe 1.

The key stored in the key safe 1 is intended to be accessible only to a specific circle of people. In order to open the key safe 1, the person must know a key code of a combination lock 2 integrated into the key safe 1 in the manner described below.

In the illustrated embodiment, the combination lock 2 has four coding elements 3 in the form of numerical wheels on which the key code of the combination lock 2 can be set.

The key safe 1 has a two-part design. First of all, it includes a wall plate 4 that can be appropriately fixed to the previously mentioned mounting surface. In the illustrated embodiment, the wall plate 4 is circular. Near its outer edge 5, the circular plate 4 has a circular groove 6 that extends all around the circular plate 4.

Moreover, a control cam 7 of a wiping mechanism for scrambling the key code of the combination lock 2 is provided on the wall plate 4 in the illustrated embodiment. In the here illustrated embodiment of the key safe 1 shown in FIGS. 1 and 2, this control cam 7 extends over a peripheral angle of about 25° to 45°. Moreover, latch formations 9 and 10 are formed on a cylindrical projection 8 of the circular plate 4 for engaging and blocking a latch member 11 of the combination lock 2 when the key code is not set on the combination lock 2.

In the illustrated embodiment, the combination lock 2 is received and fixed by a retaining plate 12 inside a hemispherical housing 13 of the key safe 1. In the illustrated embodiment of the key safe 1, the housing cap or dome 13 is, as mentioned previously, hemispherical and has on its edge 14 directed toward the wall plate 4 a cylindrical rim 15 that forms the edge 14. When the key safe 1 is closed, the edge 14 is received in the wall-plate circular groove 6.

On the inner face of the cylindrical portion 15 of the housing 13 not visible in the figures, housing-part bayonet projections (not visible in FIGS. 1 and 2) are formed that, together with wall-plate bayonet retaining member 16, form a bayonet joint that can fix the housing 13 and the wall plate 4 of the key safe 4 to one another.

The combination lock supported inside the housing 4 by the retaining plate 12 has a displacement element 17 that, in cooperation with the control cam 7 of the wall plate 4, forms a wiping mechanism for scrambling the key code of the combination lock.

Moreover, the housing 13 has grip recesses 18 that are distributed angularly on its outer surface in equal intervals over the periphery that facilitate actuation or rotation of the housing 13 relative to the wall plate 4 for the purpose of opening the key safe 1.

On its side facing away from the wall plate 4, the housing 13 has a flat portion 19 that, when the key safe 1 is in the closed state, is arranged parallel to the circular plate 4 mounted on the wall. In the illustrated embodiment, four through holes 20 are provided in the flat portion 19 through which the coding elements or numerical wheels 3 of the combination lock 2 project and can be appropriately actuated.

By virtue of the hemispherical design of the housing 13, it is especially robust mechanically. The hemispherical housing 13 does not have any projecting edges that enable the use of tools for the purpose of breaking the key safe 1 open.

In order to open the key safe 1, an authorized person who knows the key code of the combination lock 3 sets the key code of the combination lock 2 on the coding elements of the combination lock 2 that can be actuated through the holes 20 of the flat portion 19 of the housing 13. Once that has occurred, the combination-lock latch member 11 disengages from the wall-plate blocking element 9, since the combination-lock latch member 11 is biased in the direction of its release position by a spring (not shown in the figures) and can assume that position due to the appropriate positioning of the coding elements 3 of the combination lock 2 after the key code thereof has been set.

As soon as the combination-lock latch member 11 has disengaged from the wall-plate blocking element 9, the housing 13 can be rotated relative to the wall plate 4 by an angle of rotation of about 60° in the illustrated embodiment.

During this rotation of the housing 13, the combination-lock displacement element 17 of the wiping mechanism 7, 17 is actuated by the wall-plate control cam 7 of the wiping mechanism 7, 17 such that the coding elements 3 of the combination lock 2 are displaced by the combination lock-side displacement element 17 out of their position corresponding to the key code of the combination lock 2. Thus during rotation of the housing 13, the key code that was previously set by the authorized person on the combination lock 2 is scrambled. After the housing 13 has been rotated by an angle of rotation of about 60° relative to the wall plate 4, the housing-part bayonet projections are no longer underneath the wall-plate bayonet retaining members 16, so that the housing 13 can be lifted or removed from the wall plate 4 and the key safe 1 opened. Due to the scrambling of the coding elements 3 of the combination lock by the wiping mechanism 7, 17, the key code of the combination lock 2 is no longer visible on the housing.

To close the key safe 1, the housing 13 is placed onto the wall plate 4 so the edge 14 of the housing 13 fits in the circular groove 6 of the wall plate 4. Once the housing-part bayonet projections come to rest against the upper side of the wall-plate bayonet retaining members 16, the housing 13 is rotated until the housing-part bayonet projections are no longer held by the upper sides of the wall-plate bayonet retaining members 16. The housing 13 is then located in a position relative to the wall plate 14 in which, as a result of rotation of the housing 13, the housing-part bayonet projections go under the wall-plate bayonet retaining members 16. Upon rotation of the housing 13, the combination-lock latch member 11 engages the wall-plate latch formations 9, 10. For this purpose, the wall-plate latch formations 9, 10 have spring-mounted entry portions 21 that are provided with an inclined surface and are shown in FIG. 2 outside of the respective recesses,

Moreover, FIG. 2 shows that, in the case of this embodiment, the control cam 7 is divided into two parts, with each part of the control cam 7 cooperating with the displacement element 17 of the combination lock 2 that is also provided in two parts, and with only one of the two parts of the displacement element 17 shown in FIG. 2.

1. A key safe for attachment to a mounting surface, the key safe comprising:
a wall plate that can be fixed to the mounting surface and on which at least one key can be supported,
a housing that can cover the wall plate and the at least one key, and
a combination lock that can secure the wall plate and the housing to one another when the key safe is closed, the housing having a generally circular edge that is directed toward the wall plate such that the housing can be rotated relative to the wall plate when the key code is set on the combination lock, and that, after a rotation through a predetermined angle relative to the wall plate, the housing is separable from the wall plate.

2. The key safe defined in claim 1, further comprising:
a wiping mechanism for wiping the key code of the combination lock that includes an adjustment mechanism of the combination lock and a control cam that, after the key code is set on the combination lock and the housing is rotated relative to the wall plate, displaces coding elements of the combination lock out of their position that corresponds to the key code.

3. The key safe defined in claim 1, wherein the predetermined angle is about 60° and the control cam of the wiping mechanism extends over about 25° to 45°.

4. The key safe defined in claim 1, wherein the housing is connected by a wire, band, etc. to the wall plate.

5. The key safe defined in claim 2, wherein the combination lock is mounted in the housing that is a dome or cap, and the control cam is mounted on the wall plate.

6. The key safe defined in claim 5, wherein the dome or cap housing is hemispherical with a cylindrical portion on its edge that is directed toward the wall plate and a flat portion that is spaced from and parallel to the wall plate.

7. The key safe defined in claim 6, wherein the wall plate is a circular plate whose outer edge is formed with a circular groove in which the edge of the housing that is directed toward the wall plate can be received.

8. The key safe defined in claim 1, wherein the cap-side combination lock has a latch member that, when the key safe is closed and the combination lock has been moved out of the key code, is in blocking engagement with latch formations formed on the wall plate, and when the key code of the combination lock is set, can be released from the blocking engagement with the wall-plate latch formations.

9. The key safe defined in claim 1, further comprising between the housing and the wall plate:
bayonet joint that can only be opened when the key code has been set on the combination lock and the housing has been rotated by the predetermined angle relative to the wall plate.

10. The key safe defined claim 1, further comprising:
at least four grip recesses formed on the outer surface of the dome or cap housing.
